(19) United States
(12) Patent Application Publication
(10) Pub. No.: US 2014/0200912 A1
(43) Pub. Date: Jul. 17, 2014

(54) Rapid Medical Connection (RMC) related to Real Time Health Care service VIA an INTELLIGENT Short Message System (SMS) based platform

(71) Applicant: Medtext Communications, LLC, (US)

(72) Inventors: Howard Baruch, Englewood, NJ (US); Elaykim Orlinsky, Riverdale, NY (US); Daniel Reidler, New York, NY (US); Daniel Harcsztark, Engelwood, NJ (US); David Berkowitz, Woodcliff Lake, NJ (US)

(73) Assignee: Medtext Communications, LLC, Teaneck, NJ (US)

(21) Appl. No.: 13/848,170

(22) Filed: Mar. 21, 2013

Related U.S. Application Data
(60) Provisional application No. 61/613,785, filed on Mar. 21, 2012.

(51) Int. Cl. G06Q 30/06; G06Q 50/22

(52) U.S. Cl. CPC G06Q 30/0623; G06Q 50/22
USPC 705/2

(57) ABSTRACT

The present invention is a system and method of facilitating medical treatment comprising: providing a first health care provider access to a system stored on a non-transitory computer-readable medium, said program configured for facilitating medical treatment of a patient; accessing said system by said first health care provider; inputting information of a patient in need of a second healthcare provider into said system; transmitting said input information to a system controlled transmission-receiving device; and directing said transmitted input to a second health care provider, wherein said directing is based on selectable criteria by said accessing health care provider.

### INDEX TO RELATED APPLICATIONS

This application is a non-provisional of and claims benefit to U.S. Provisional Patent Application No. 61/613,785 filed Mar. 21, 2012 the disclosure of which is incorporated herein by reference in its entirety.

### BACKGROUND OF THE INVENTION

### Field of the Invention

Currently, there is no widely accepted way for an individual to find a healthcare physician by phone. An injured patient would have to seek out a physician by peer recommendation or calling multiple doctors for a referral. Referral, as used herein is not intended to be limiting and includes not only a direct referral, but providing a lead to a provider receiving the referral. Once the patient found the phone number for the necessary specialist, he would call the office to schedule an initial appointment. After meeting with his first physician, the patient may require referrals from the doctor to other specialists which would restart the process of finding phone numbers and calling for appointments.

This method requiring an initial physician evaluation and referral to a specialist is both timely and expensive for the patient. Similarly, the referring physician receives limited recognition for a referral and may also lose the patient from his hospital or referral network as the patient seeks alternative avenues for finding a proper physician.

There exists a need for the more efficient method of referring patients and for the referring physician to receive recognition from peers related to referrals.

### SUMMARY OF THE INVENTION

The present invention is a process for individuals (PATIENTS AND HEALTH CARE PROVIDERS) to rapidly find and connect with healthcare specialists in order to schedule appointments, bypassing the current inefficiencies by optimizing communication in the first ten seconds (MOMENTS) of healthcare.

In one embodiment, the present invention utilizes existing Short Message System (SMS) technology and an intelligent algorithm to filter and record user activity. However, any acceptable rapid communication method is contemplated in the present invention. One embodiment utilizes MMS technology to transmit not only patient contact info, but a video image of a medical condition to be addressed.

In one embodiment according to the present invention, the referring physician transmits his or her own contact information and diagnosis. Because there is a trail of transmission, subsequent health care providers have a way to readily contact the referring health care provider if additional inquiries are desired.

In one aspect, the invention is a method for creating intelligence in text messaging and implementing this technology in the healthcare industry. The method includes integrating real time patient needs with the correct real time healthcare services so that physicians can refer patients to other doctors, and patients can find physicians and schedule appointments without a time consuming search.

In one embodiment, the invention is a method for creating intelligence in healthcare text-messaging. The method includes integrating immediate real time patient needs with the correct real time healthcare services: integrating components needed by the patient with Healthcare components, that meet those needs instantaneously. By analysis of metadata and intelligently implementing complex methods by associating analysis with Healthcare needs at the first most critical moment all that follows is immediate, instantaneous, more effective, lessons to safer, faster, more appropriate and more cost effective treatment.

Associating care with metadata instantaneously at the moment a patient needs care. The present method, not only analyzes the metadata, but also provides processing software to process and utilize metadata consistent with the goals, of the present invention.

The method also includes transferring messages from the instantaneous decision point, determines a status, intelligently analyzes needs and determines status of care, care requirements and executes the needed care and service based on messages and metadata.

In another aspect, the invention is an apparatus for adaptive Patient profiling. The apparatus includes Circuitry to integrate Patient (jc) components used in providing a treatment, (immediate care), associates the care components used in providing care to the metadata, transfer messages from the care components and determine a status of care based on metadata and messages.

In another embodiment of the present invention, the invention intelligently identifies best provider (healthcare service) and executes the connection between patient and provider.

In another embodiment of the present invention, an article that includes a machine-readable medium that store exactable instructions on a non-transitory medium for adaptive care profiling. The executable instructions cause archive to integrate Patient (Healthcare) components used in the care of the patient, associate the care components to metadata, transfer messages from the Patient component, sterling a status of the Patient care base pm the messages meta data and execute a solution specific to care needs immediately.

In another embodiment of the present invention the invention is an adaptive patient (Healthcare) profiler system. The system includes a patient (Healthcare) component representing a patient (Healthcare) entity, a messaging infrastructure to receive messages from the Patient, doctor, healthcare provider, and the metadata database having metadata. The system also includes an intelligent agent integrating the Patient (jc) component to the messaging infrastructure.

The intelligent agent creates real time communication of messaging between patient and healthcare provider:

Between the Patient (Healthcare) component and messaging infrastructure.

The system further includes a sentinel agent to receive messages from Patient (Healthcare). The sentinel agent determines in real time a status of the care base on messages and the meta data base.

### Modifying Current Processes—Specific Differences

### Referring Physician

Referring Physician notifies both the patient and the referred to physician of the referral This in turn, enables the physician's office to immediately contact the patient and schedule them in limited the attrition between referral and referred to physician contact

### Referred to Physician

Also, by targeting a known new patient, the physician can allocate schedule slots for these patients in the very near term, so turnaround from initial contact to scheduled appointment is as rapid as the patient desires. Additionally, with permission of the patient, the referring physician can communicate medical information to referred to physician, which will act to further enhance the probability of a patient arriving at the physician's office.

### Both Practices

Additionally, with permission of the patient, the referring physician can communicate medical information to referred to physician, which will act to further enhance the probability of a patient arriving at the physician's office. Additionally, since all of the referral traffic activity is captured, stored, consolidated and disseminated, all referral network participants will be able to quantify the value to their practice of referring and receiving referrals using the MedText model.

### Patients

The responsibility that currently resides with patients for following through with a referral is alleviated by placing the responsibility on to the referring physician. Additionally, even if a patient is proactive in contacted the referred to physician, navigating through the process of waiting on the phone, and getting an appointment later than they want, can be cumbersome. By contacting the patient immediately and directly and having schedule slots open, possibly even for that day, there is a closer lock-in to the referred to physician.

In one embodiment, the present invention is a method of facilitating medical treatment, the method comprising the steps of:

providing a first health care provider access to a system stored on a non-transitory computer-readable medium, said program configured for facilitating medical treatment of a patient; accessing said system by said first health care provider;

inputting information of a patient in need of a second healthcare provider into said system;
transmitting said input information to a system controlled transmission-receiving device;
directing said transmitted input to a second health care provider, wherein said directing is based on selectable criteria by said accessing health care provider.

In the method, the system is accessed by Internet, SMS, MMS, telephone, or combinations thereof. Preferably, access is restricted by password, encryption, biometrics, or combinations thereof.

The inputting of information is a first set of information and includes a patient name, condition, insurance provider, referring healthcare provider, severity, urgency, and/or combinations thereof. The inputting information, in one embodiment, further includes visual information including photos, videos, and/or combinations thereof.

Transmitting is by SMS, MMS, Internet, or combinations thereof and is followed by receiving said information by a receiving healthcare provider according to said selected criteria.

In one embodiment, the transmitting is to a controller constructed and arranged to receive the first set of information, prepare an output of a second set of information and transmit the output. In one embodiment, the output is redacted in order to comply with privacy rules such as HIPPA and the like. The output goes to a second health care provider to which a referral is made. The second healthcare provider is provided with communications information in which to contact said patient. In one embodiment, the second healthcare provider is provided with communications means and a system generated directive to contact said patient within 0.01-5 minutes of receipt of said patient information.

The second healthcare provider is required to confirm with said system that contact with said patient has been completed. The second healthcare provider is required to confirm with said system that contact with said patient has been completed and said second healthcare provider receives reminders from said system until said second healthcare provider confirms contact with said patient.

The present invention further includes a system for facilitating medical treatment, said system comprising:

a controller constructed and arranged to receive a first set of information submitted to the controller and to transmit a second set of information based on said first information;

a database having a computer readable medium operatively associated therewith, said database constructed and arranged to interact with said controller and configure output of information based on said first set of information and said second set of information;

said database further constructed and arranged for local access, remote access, or combinations thereof.

The first information is received by the controller when transmitted by Internet, SMS, MMS, telephone, or combinations thereof.

The second set of information is transmitted to a patient, health care provider, or combinations thereof. In one embodiment, the second set of information is transmitted within 0.01-5.00 minutes after said first information is received by the controller.

### BRIEF DESCRIPTION OF THE SEVERAL VIEWS OF THE DRAWING

FIG. 1 shows a functional block diagram illustrating the existing process.

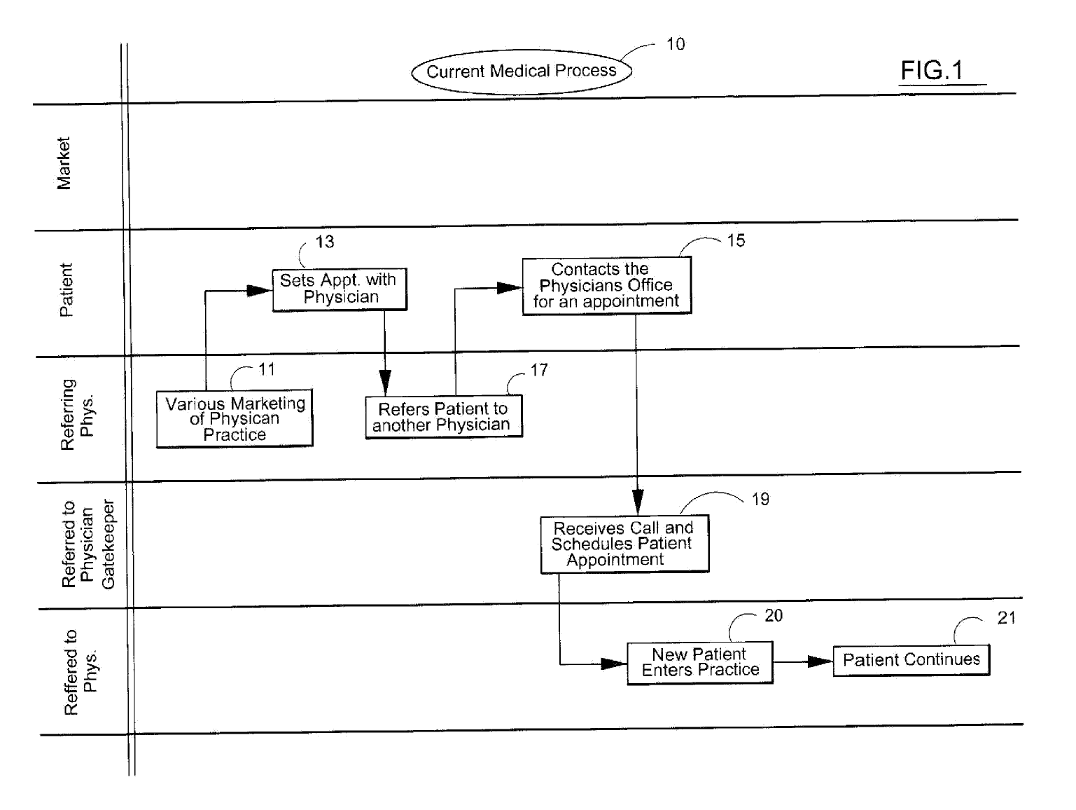

FIG. 2 is a representation demonstrating existing processes and deficiencies in these processes.

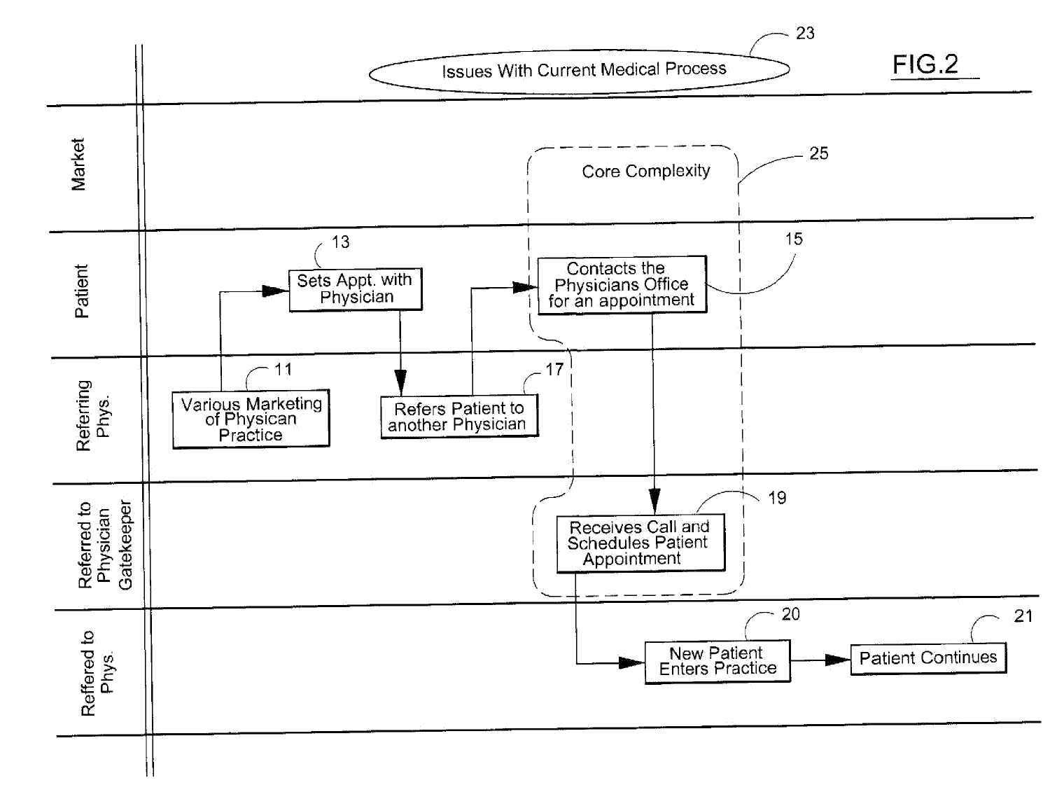

FIG. 3 is a representation of the present invention in its first embodiment.

FIG. 4 is a representation of the present invention in its first embodiment continuation of the chart from FIG. 3.

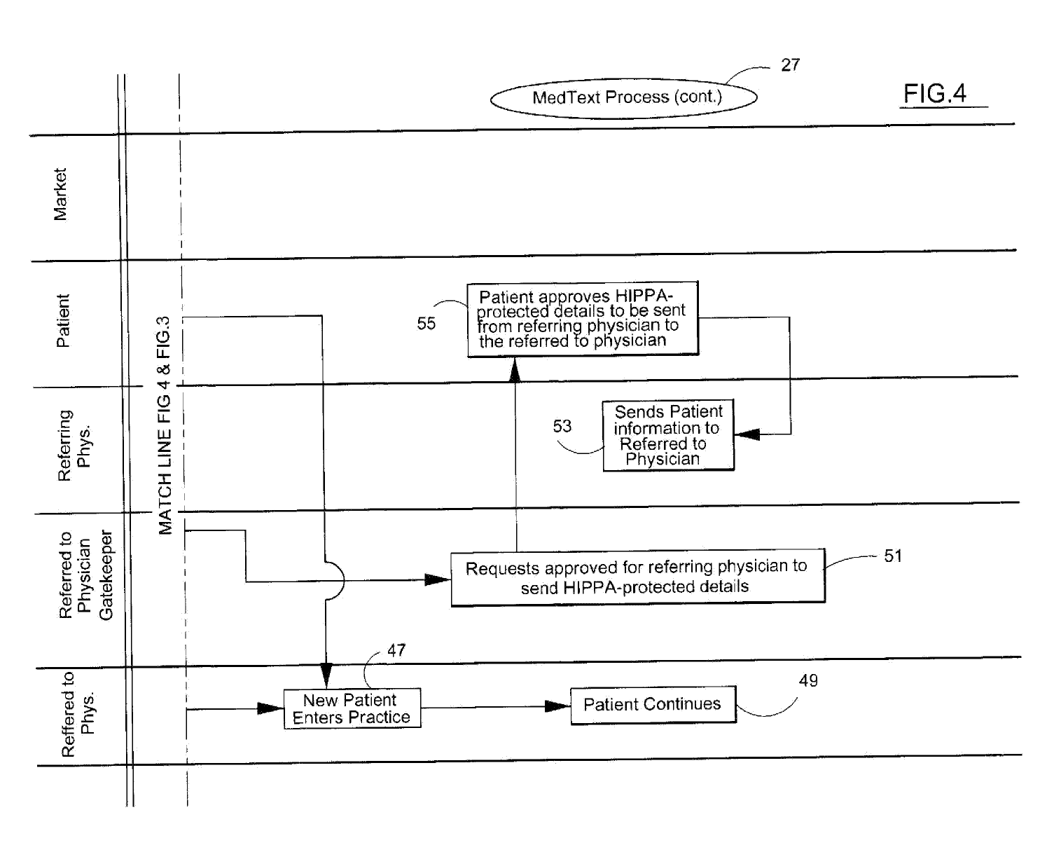

FIG. 5 is a representation of the present invention and its advantages.

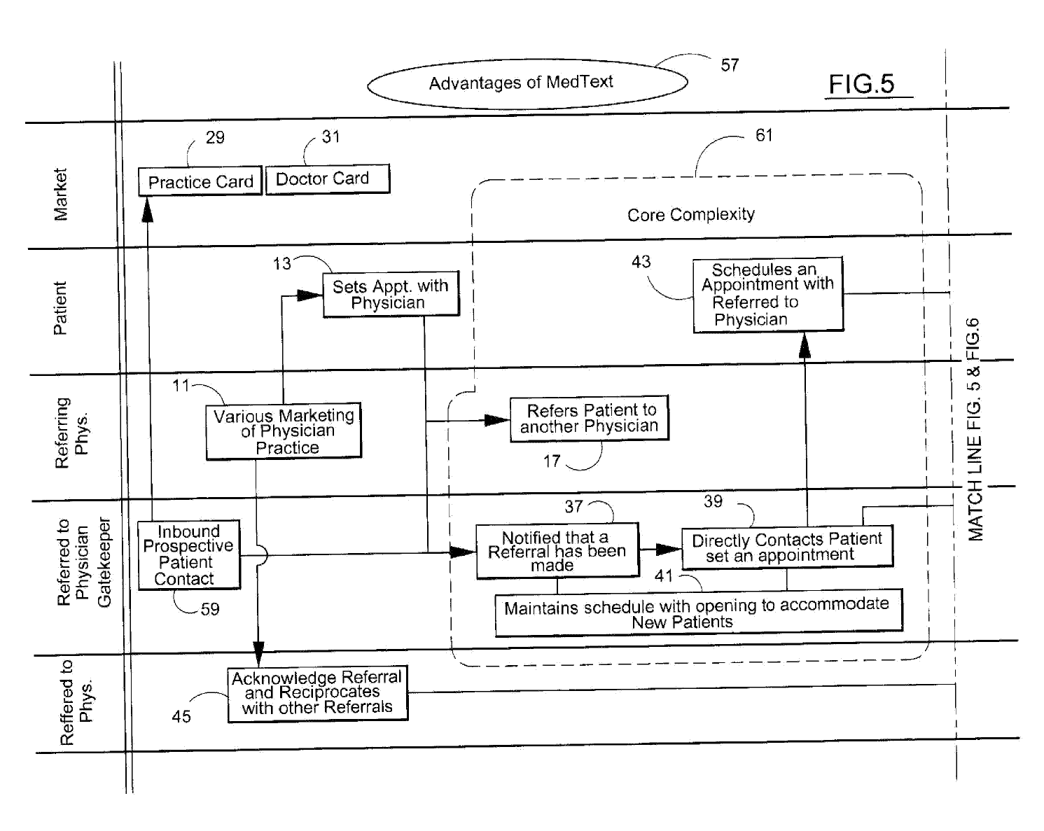

FIG. 6 is a representation of the present invention and its advantages as continued from the chart on FIG. 5.

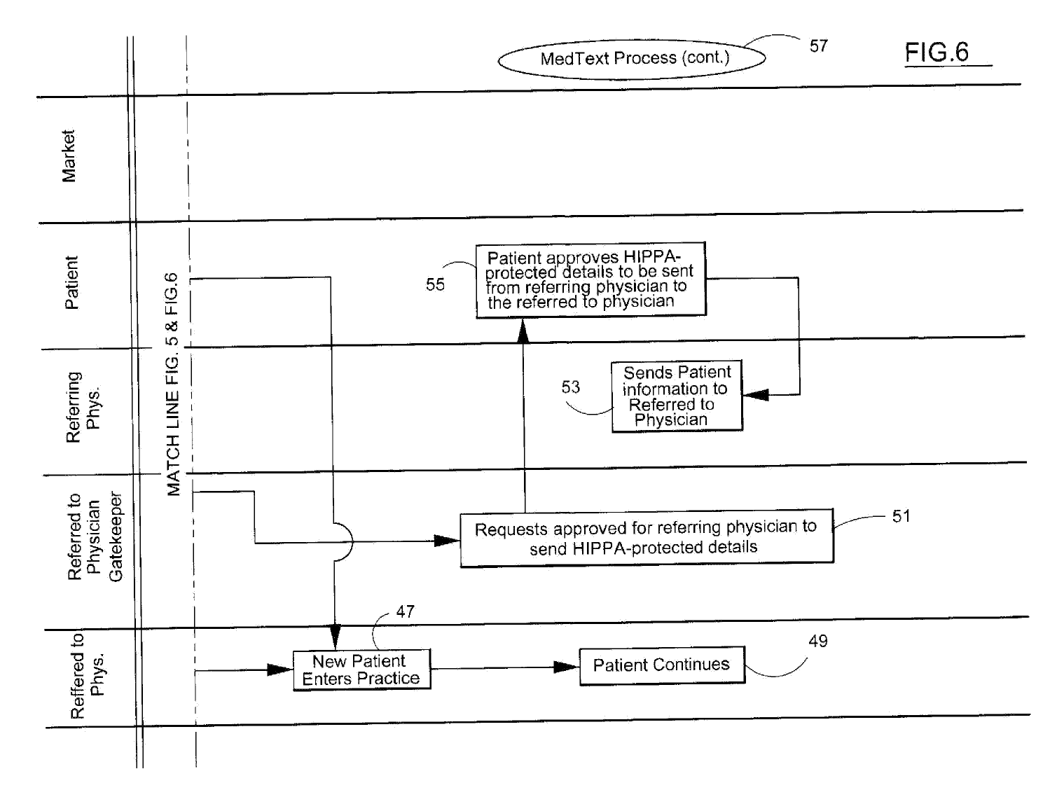

### DETAILED DESCRIPTION OF THE PREFERRED EMBODIMENT

The present invention will be described more fully with reference to the accompanying figures.

The term “DOCTOR card” refers to the unique data recording of a doctor's information (fields: contact information, specialty, practice group, etc.) and is used in this document as the physical display of the SMS which all physicians registered with the system are assigned.

The term “intelligent algorithm” refers to the intake of data via a short message system (from the patient or doctor) and the output of data to the patient/doctor conditioned on keywords. The intelligent algorithm outputs data, based on processing of metadata.

The term “database” refers to the collection of DOCTOR cards and patient data.

The term “patient” refers to an individual seeking healthcare.

The term “doctor” refers to any healthcare provider. In one embodiment, term is used to describe a physician or physician practice that has registered with the service.

The term “patient data” refers to an otherwise unidentified mobile number from which a text message is sent to the software.

The term “software” refers to the system that acts on the data.

The term “most appropriate” refers to the doctor who is referenced in a message based on the intelligent algorithm, or is matched based on keyword.

The term “keyword” refers to a medical specialty area (i.e. knee, spine), insurance carrier, doctor's name, etc.

The term “server's actions” refers to the date, time, referring doctors name and information, metrics of who sends patients to the doctor, metrics to whom the doctor sends patients.

The following briefly describes an embodiment of the invention in order to provide a basic understanding of its use. This description is not intended to limit the potential uses for the present invention.

In one embodiment, the system of the present invention includes a computer executable algorithm stored on a computer readable medium and operatively associated with a computer microprocessor. As understood in the art, the computer readable medium is non-transitory. The initial access to the system of the present invention is by a healthcare provider. Typically, this is a physician but it is not limited to such.

The system and method of the present invention provides unique patient referral and is constructed and arranged to process, sort, and output patient information. In one embodiment, patient information, whether input or output into the system of the present invention, is configured to comply with privacy requirements in the location where the system is being used. One example would be in the United States having a system configured to comply with current HIPPA requirements.

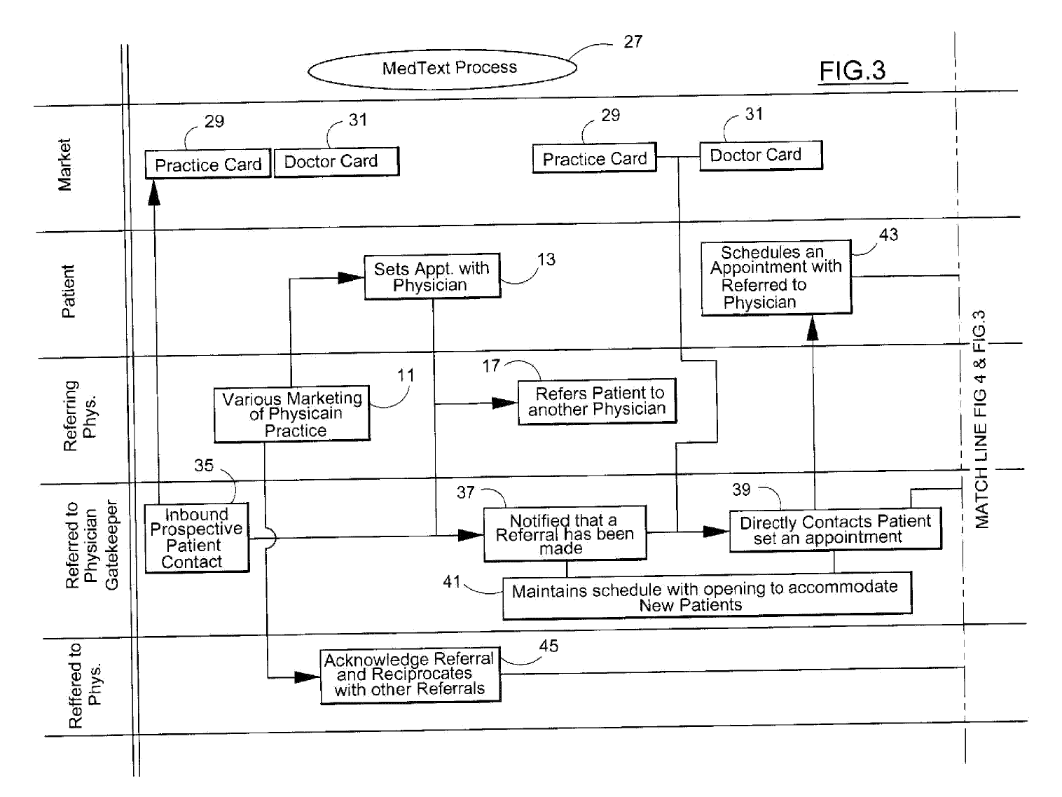

In one embodiment, as depicted in the diagram of FIG. 3, a patient at a doctor's office requires a referral to a specialist.

### Initialization

The process 27 is initiated when an inbound patient 35 is referred to a physician. Patient 35, in one embodiment encounters marketing 11 and sets an appointment with a physician 13. Physician 13 refers patient to secondary physician 17. A secondary physician 17 is any position to which a referral has been made. In one embodiment, this refers to a specialist. However it is not required that secondary physician 17 be a specialist. Once referral has been made a notification 37 is sent and the referring physician sends a contact to patient 39 to schedule an appointment 43 with the secondary physician.

In one example, Doctor A (“DrA”) 13 initiates a request to the MedText software in the form of an SMS message in order to connect patient (“P”) and Doctor B (“DrB”) 17. The body of the SMS message is composed to match a predefined syntax consisting of actionable keywords and uniquely identifiable data.

Processing—The SMS is delivered via shortcode (a 6-digit phone number) through an SMSC gateway to the server. The request and its data are stored in a database. The intelligent algorithm parses out the actionable keywords or verbs and processes the content of the SMS. Data relevant to each party or noun (e.g. DrA & DrB) are appropriately stored for later retrieval. Assuming the request is correctly formatted, at least three new messages are composed and queued for delivery via the SMSC gateway.

### Delivery & Confirmation

A patient enters a new practice 47 the requests for referring physician are approved at step 51 and the patient approves hip a protected deep details at step 55 subsequent to approval the of the system sends the patient information 53 to the referring physician.

The software processes the queue of new SMS messages generated by the algorithmic processing of the initial request by DrA. The first message is delivered to P and contains Dr. B's DOCTOR card. The second consists of a message to DrB notifying him of the new connection made by DrA, along with the patient data. The number of messages that are sent in this instance are variable, as DrA has the ability to connect P with multiple other doctors. In the case of multiple doctors (e.g. DrB0, DrB1, DrB2, . . . ) each would receive one SMS of a similar nature. The doctor(s) can now contact P for an appointment. The final message gets delivered to DrA to confirm the success or failure of the transaction he initiated.

Archiving—Doctors are able to reference past leads in which they have received or initiated via a Web-based platform that compliments the SMS-based procedure. This platform enables doctors to further extend each transaction with additional notes, tags, statuses and other information at his discretion.

In another embodiment as depicted in the diagram of FIG. 3, a patient needs to see a doctor and has not been referred. He initiates a request to the MedText software in the form of an SMS with a keyword or series of keywords.

The body of the SMS message is read by the intelligent algorithm software for actionable keywords to identify the most appropriate physician. The patient receives a message with the generated DOCTOR card as the doctor receives the patient data. The web-based platform records the server's actions and enables the doctor to track the referral. The doctor in turn, calls the patient in real time to schedule an appointment or give an alternative referral.

This unique process provides a new system for enabling rapid patient connection and referrals. In another aspect, the invention is an adaptive patient (Healthcare) profiler system. The system includes a patient (Healthcare) component representing a patient (Healthcare) entity, a messaging infrastructure to receive messages from the patient, doctor, or healthcare provider, and the metadata database. The system also includes an intelligent agent integrating the patient (Healthcare) component to the messaging infrastructure. The intelligent agent creates real time communication of messaging between patient and healthcare provider.

In one embodiment, the system and method of the present invention provides creating an immediate connection and will create access at all levels of healthcare.

In one example, a patient sends a text message:

Example: TEXT: “SPINE” to “DOCTOR” (362-867)

### DRBARUCH to DOCTOR

### NYU,SPINE to DOCTOR

### NYU,SPINE,USHC to DOCTOR

The present invention utilizes proprietary software having the unique ability to easily scale to 42,000 zip code and 230 area codes and every point on earth.

if you are looking for a spine surgeon anywhere in the U.S. just text

### SPINE to DOCTOR

The process in one embodiment continues:

Flow: Medtext identifies your location and provides you with:

1) Contact information of a “board certified” spine surgeon in your zip code or area code.

2) Your new spine surgeon gets your cell phone and the provider, provider's office and/or a call center call you within 10-120 seconds to speak with you and schedules you to see the spine surgeon.

3) all actions are tracked on a website and the doctor or healthcare provider has access to all info:
a) patients cell numbers referred to doctor, date time
b) referring doctors name and information
c) notes on what happen to the patient
d metrics of who sends patients, to the doctor
e) metrics of who doctor sends patients to.
things it also can do identify more profitable patients by who referred patient, insurance category etc.
f) decision algorithms that will find the most cost effective treatment

Payors can also be involved in the decision tree at this most critical moment.

If a patient needs surgery text to DOCTOR: Magnacare, qualsurge Knee and u will get the most cost effective surgeon in your community to call you instantaneously.

The LOGISTICS of a New Patient referral has never been addressed at this critical second1 as in the system and method of the present invention.

Value to Insurance companies: eliminate unnecessary ER visits, use more cost effective doctors, use better outcome based doctors, use in network doctors etc., avoid unnecessary middlemen.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

We claim:

1. A method of facilitating medical treatment, the method comprising the steps of:
providing a first health care provider access to a system stored on a non-transitory computer-readable medium, said program configured for facilitating medical treatment of a patient;
accessing said system by said first health care provider;
inputting information of a patient in need of a second healthcare provider into said system;
transmitting said input information to a system controlled transmission-receiving device;
directing said transmitted input to a second health care provider, wherein said directing is based on selectable criteria by said accessing health care provider.

2. The method of claim 1 wherein said system is accessed by Internet, SMS, MMS, telephone, or combinations thereof.

3. The method of claim 1 wherein said access is restricted by password, encryption, biometrics, or combinations thereof.

4. The method of claim 1 wherein said inputting information includes a patient name, condition, insurance provider, referring healthcare provider, severity, urgency, and/or combinations thereof.

5. The method of claim 1 wherein said inputting information includes visual information including photos, videos, and/or combinations thereof.

6. The method of claim 1 wherein said transmitting is by SMS, MMS, Internet, or combinations thereof.

7. The method of claim 1 wherein said transmitting is followed by receiving said information by a receiving healthcare provider according to said selected criteria.

8. The method of claim 1 wherein said second healthcare provider is provided with communications information in which to contact said patient.

9. The method of claim 1 wherein said second healthcare provider is provided with communications means and a system generated directive to contact said patient within 0.01-5 minutes of receipt of said patient information.

10. The method of claim 1 wherein said second healthcare provider is required to confirm with said system that contact with said patient has been completed.

11. The method of claim 1 wherein said second healthcare provider is required to confirm with said system that contact with said patient has been completed and said second healthcare provider receives reminders from said system until said second healthcare provider confirms contact with said patient.

12. A system for facilitating medical treatment, said system comprising:
a controller constructed and arranged to receive a first set of information submitted to the controller and to transmit a second set of information based on said first information;
a database having a computer readable medium operatively associated therewith, said database constructed and arranged to interact with said controller and configure output of information based on said first set of information and said second set of information;
said database further constructed and arranged for local access, remote access, or combinations thereof.

13. The system of claim 12 wherein said first information is received by the controller when transmitted by Internet, SMS, MMS, telephone, or combinations thereof.

14. The system of claim 12 wherein said second set of information is transmitted to a patient, health care provider, or combinations thereof.

15. The system of claim 12 wherein said second set of information is transmitted within 0.01-5.00 minutes after said first information is received by the controller.
